(19) United States
(12) Patent Application Publication
(10) Pub. No.: US 2016/0290625 A1
(43) Pub. Date: Oct. 6, 2016

(54) Glowing Mat Device

(71) Applicant: Bryanna Tomkiewicz, New Bedford, MA (US)

(72) Inventor: Bryanna Tomkiewicz, New Bedford, MA (US)

(21) Appl. No.: 15/092,298

(22) Filed: Apr. 6, 2016

Related U.S. Application Data
(60) Provisional application No. 62/143,414, filed on Apr. 6, 2015.

(51) Int. Cl. F21V 33/00; F21V 9/16; A47K 3/00; F21V 21/092

(52) U.S. Cl. CPC F21V 33/0004; F21V 21/092; F21V 9/16; A47K 3/002

(57) ABSTRACT

A glowing mat device is provided and comprises a mat having a top surface and a bottom surface. A light activated glowing substance is associated with at least the top surface of the mat wherein the mat glows irk low light conditions.

### CLAIM OF PRIORITY

This patent application claims priority under 35 USC 119 (e) (1) from U.S. Provisional Patent Application Ser. No. 62/143,414 filed Apr. 6, 2015, of common inventorship herewith entitled, “Glow Mat,” which is incorporated herein by reference as though the same were set forth in its entirety.

### FIELD OF THE INVENTION

The present invention pertains to the field of bath accessories, and more specifically to the field of illuminable bath and floor mats.

### BACKGROUND OF THE INVENTION

For children, bath time often is associated with free spirited play. Splashing in bath water, blowing soap bubbles and drawing on tub walls with soap crayons is a fun way to get clean before heading off to bed. Accidents easily occur as small children enjoy frolicking in their bath water, slipping and sliding across the bottom of the tub in a carefree manner. The hard fiberglass or ceramic surface of a bathtub presents serious dangers to young bathers as a loss of balance can result in the little one banging their head, back, arms or legs on the sides or bottom of the tub. Countless conscientious parents employ bath tub mats when bathing their children. Bathtub mats are practical in that they protect the bather from slipping while in the tub, as well as provide a cushiony seat for a child's tender bottom.

The prior art has put forth several designs for illuminable bath and floor mats. Among these are:

US Patent 2014/0375434 to Daniel C. Puljan describes bathmats that include lights, a power source, and a computer configured to control the illumination of the lights. Several bathmat embodiments include water resistant enclosures. Some bathmat embodiments include communication devices capable of wirelessly communicating with a computing device located remotely relative to the bathmat.

U.S. Pat. No. 8,475,026 to Maarten Marinus Johannes Wilhelmus Van Herpen and Marcinellus Petrus Carolus Michael Krijn describes a light emitting tufted carpet with a primary backing layer permeable to light, an optional adhesive layer, a waveguide comprising a light out coupling site, and an optional secondary backing layer. The primary backing layer is provided with tufts. The waveguide is arranged to couple light source light of a light source in as waveguide light, and arranged to couple waveguide light out at the waveguide light out coupling site to provide carpet light. The waveguide light out coupling site is below the primary backing layer.

U.S. Pat. No. 7,670,026 to Victor Jonathan Hawkins describes an apparatus for providing illumination including a lower light panel that contains at least one battery and electronic control circuitry therein. A plurality of LEDS are each disposed in a corresponding plurality of recesses in the light panel. A reflective coating is preferably included in each of the recesses. A clear plastic sheet is disposed over an upper surface of the light panel. A rug is disposed over the light panel and is detachably attached thereto. When a person steps on the rug, one or more of a plurality of pressure activated switches are energized which, in turn, activates the circuitry and energizes the LEDS. The LEDS are illuminated for a first predetermined period of time that is selectable. When the first timer elapses, the lights and circuitry turn off and the apparatus returns to a quiescent state until the cycle is repeated. The rug is removed from the light panel for cleaning of the rug and the plastic sheet is also removed for servicing of the light panel.

U.S. Pat. No. 6,417,778 to Ronald D. Blum and Dwight P. Duston describes an advanced floor mat that includes a cleanable portion. The floor mat also includes a water dissipation component, a water absorbing component, a cushioning component, customized graphics, a transparent cleanable portion, a tacky surface on the cleanable portion, an antibacterial composition, an antifungal composition, and a fragrance. Additionally, the cleanable portion is erodible and includes a plurality of cleanable reusable layers.

None of these prior art references describe the present invention.

### SUMMARY OF THE INVENTION

It is an object of the present invention to provide a cushiony bathtub mat that contains glow in the dark capability and provides a safe and comfortable surface on which a child can frolic and play in the bathtub.

The present invention is a glowing mat device and comprises a mat having a top surface and a bottom surface. A light activated glowing substance is associated with at least the top surface of the mat wherein the mat glows in low light conditions.

In addition, the present invention includes a method for constructing a glowing mat device. The method comprises providing a mat having a top surface and a bottom surface, associating a light activated glowing substance with at least the top surface of the mat, introducing the glowing substance to a light source, and glowing the mat in low light conditions.

The present invention further includes a glowing mat device comprising a mat having a top surface and a bottom surface. A light activated glowing phosphor substance is embedded or encapsulated in at least the top surface of the mat. A light source energizes the glowing substance wherein the mat glows in low light conditions.

### BRIEF DESCRIPTION OF THE DRAWINGS

FIG. 1 is a perspective view illustrating a glowing mat device, constructed in accordance with the present invention, with the glowing mat device positioned in a bathtub in a dimmed bathroom, showing how the glowing mat device is manufactured from a specially formulated rubber material mixed with a phosphorescent powder that brightly glows in dimmed light.

FIG. 2 is another perspective view illustrating the glowing mat device, constructed in accordance with the present invention, with the glowing mat device positioned in a bathtub in a blacked out bathroom, showing how the glowing mat device is manufactured from a specially formulated rubber material mixed with a phosphorescent powder that brilliantly glows in a dark room.

FIG. 3 is still another perspective view illustrating the glowing mat device, constructed in accordance with the present invention, with the glowing mat device positioned in a bathtub in a blacked out bathroom, showing how the glowing mat device is manufactured from a specially formulated rubber material mixed with a phosphorescent powder that brilliantly glows in a dark room.

FIG. 4 is an elevational side view illustrating the glowing mat device, constructed in accordance with the present invention, showing the suction cup securing means on a bottom surface of the glowing mat device.

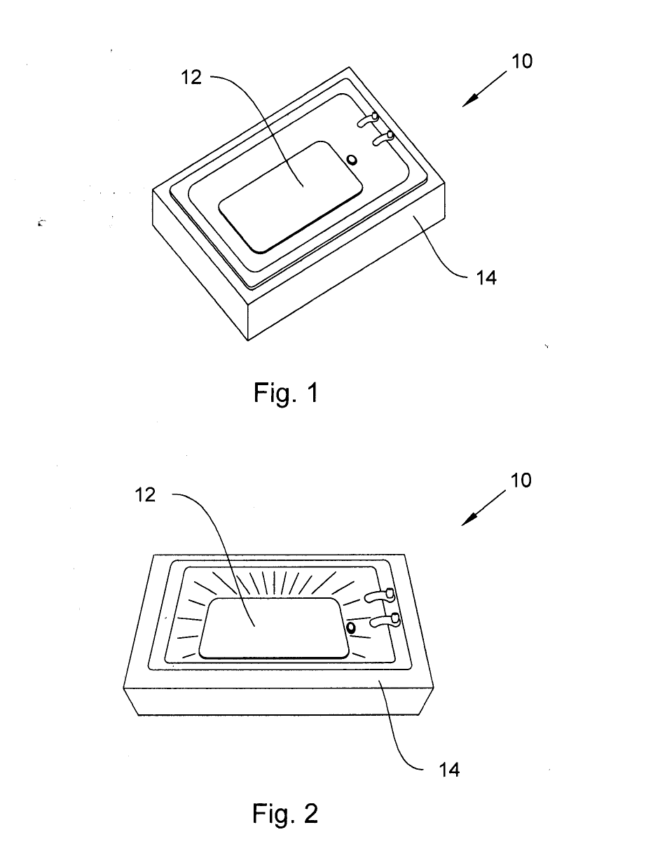

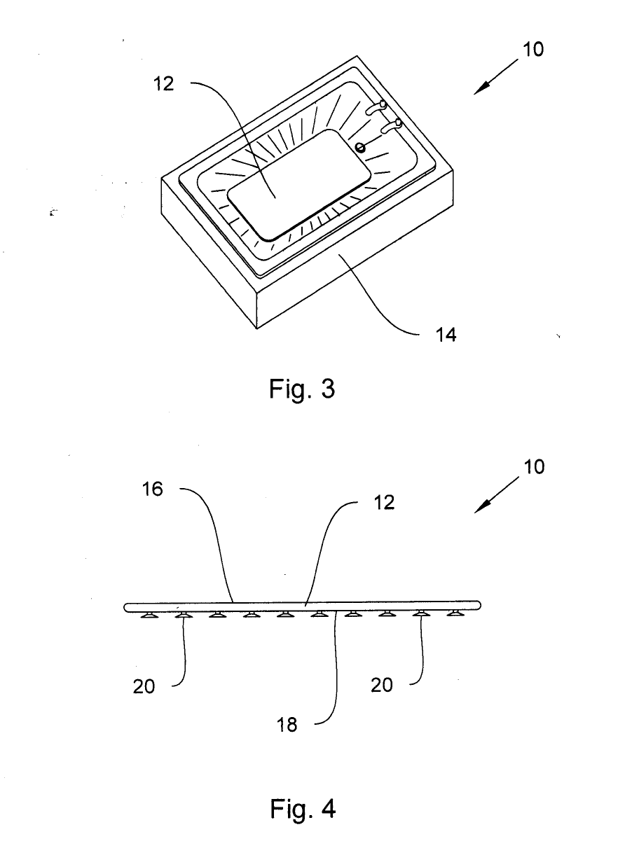

### DETAILED DESCRIPTION OF THE INVENTION

The present invention, hereinafter referred to as a Glowing Mat Device, indicated generally at 10, can be any type of mat 12 but is preferably a cushiony mat 12 that contains glow in the dark capability. The mat 12 of the Glowing Mat Device 10 can be any type of mat 12 or floor covering including, but not limited to, bath mats, bath tub mats, shower mats, floor mats, door mats, closet mats, garage mats, automotive mats, breezeway mats, anti-fatigue mats, etc. In the case of the bathtub mat 12, the Glowing Mat Device 10 provides a safe and comfortable surface on which a child can frolic and play in the bathtub 14.

The glow in the dark properties of the Glowing Mat Device 10 of the present invention illuminate the surface of the mat 12 during use. The mat of the Glowing Mat Device 10 can provide additional safety for the users and functions to capture a child's attention by means of a bright colorful glow.

In a preferred embodiment of the bathtub mat 12, the mat 12 of the Glowing Mat Device 10 of the present invention is a rectangular shaped mat 12 sized appropriately to encompass the floor of a standard bathtub 14. Manufactured from a cushiony rubber or plastic material, the mat 12 has a top surface 16 containing a soft nonskid coating to facilitate comfortable seating and secure footing when the bather is climbing in and out of the bathtub. Positioned on a bottom surface 18 of the mat 12 of the Glowing Mat Device 10 is a series of soft rubber suction cups 20 securing the bathmat 12 to the tub floor and prevent the bathmat 12 from slipping about during use.

It should be noted that the bathtub mat 12 of the Glowing Mat Device 10 of the present invention has been described as being constructed from a rubber or plastic material, the other types of mats 12 in the collection of the Glowing Mat Device 10 can actually be constructed from different materials including, but not limited to, cushiony and plush fabric, vinyl, foam, memory foam, recycled plastic and rubber, etc.

The glow in the dark top surface 16 of the mat 12 of the Glowing Mat Device 10 of the present invention employs a phosphor powder that is energized by normal light and has a very long persistence. Two employable phosphors that have these properties are Zinc Sulfide and Strontium Aluminate. The preferred phosphor to be employed with the Glowing Mat Device 10 is Strontium Aluminate which is a newer form of phosphor that has a much longer persistence than Zinc Sulfide. This phosphor substance is embedded or encapsulated within the rubber or plastic material that comprises the mat 12 and is charged by way of normal sunlight or ambient lighting. It should be noted that the phosphor substance can be infused in the top surface 16 of the mat 12 or infused throughout the mat 12 from the top surface 16 to the bottom surface 18. In addition, the Glowing Mat Device 10 is available in a variety of hues common to phosphorescent goods including gold, green, pink and orange.

Using the bathtub mat 12 of the Glowing Mat Device 10 of the present invention is simple and straightforward. A parent or caregiver selects a mat 12 in a preferred glow emission color and places it with suction cups 20 facing down into the bathtub 14 used on a regular basis by the child or children. The parent or caregiver stands and steps firmly about the mat 12, to press it securely to the floor surface of the bathtub 14. After stepping from the bathtub 14, the installer leans down and pushes firmly against the mat 12 ensuring it is stably secure and does not slip or move on the floor. At bath time, the parent or caregiver runs water into the bathtub 14, double checks to make sure the mat 12 is secure to bathtub floor, and brings the child into the tub for their bath. If giving a child a bath at night, the parent turns off or dims the bathroom lights, to activate emission of glowing light from the bottom of the bathtub 14, capturing the child's attention and adding a new level of fun to a bath time routine. After the bath, the parent or caregiver turns up the bathroom lights, takes the child from the bathtub 14, and proceeds with helping the child towel dry their body and put on their sleepwear.

Although the Glowing Mat Device 10 of the present invention is configured primarily for use by children, it also provides adults with a fun and relaxing bath of glowing water and a safe mat 12 on which to stand while climbing in and out of a bathtub 14. The Glowing Mat Device 10 provides a comfortable and padded a protective barrier between a bather's body and a hard bathtub 14 made of porcelain or fiberglass. Durably constructed, the Glowing Mat Device 10 will withstand continued use in homes, hotels, motels and similar establishments.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A glowing mat device comprising:
a mat having a top surface and a bottom surface; and
a light activated glowing substance associated with at least the top surface of the mat;
wherein the mat glows in low light conditions.

2. The glowing mat device of claim 1 wherein the mat is selected from the group consisting of bath mats, bath tub mats, shower mats, floor mats, door mats, closet mats, garage mats, automotive mats, breezeway mats, and anti-fatigue mats.

3. The glowing mat device of claim 1 wherein the mat has a substantially rectangular configuration.

4. The glowing mat device of claim 1 wherein the mat is constructed from a cushiony rubber or plastic material.

5. The glowing mat device of claim 1 wherein top surface of the mat includes a nonskid coating.

6. The glowing mat device of claim 5 wherein the bottom surface of the mat includes a plurality of suction cups.

7. The glowing mat device of claim 1 wherein the mat is constructed from a material selected from the group consisting of cushiony and plush fabric, vinyl, foam, memory foam, and recycled plastic and rubber.

8. The glowing mat device of claim 1 wherein the glowing substance is a phosphor energizable by normal light.

9. The glowing mat device of claim 8 wherein the phosphor is selected from the group consisting of Zinc Sulfide and Strontium Aluminate.

10. The glowing mat device of claim 8 wherein the phosphor substance is embedded, encapsulated, or applied within or to the top surface of the mat.

11. The glowing mat device of claim 1 wherein the glowing substance has a color selected from the group consisting of gold, green, pink, and orange.

12. A method for constructing a glowing mat device, the method comprising:
providing a mat having a top surface and a bottom surface;
associating a light activated glowing substance with at least the top surface of the mat;
introducing the glowing substance to a light source; and
glowing the mat in low light conditions.

13. A glowing mat device comprising:
a mat having a top surface and a bottom surface;
a light activated glowing phosphor substance embedded or encapsulated in at least the top surface of the mat; and
a light source for energizing the glowing substance;
wherein the mat glows in low light conditions.

14. The glowing mat device of claim 13 wherein the mat is selected from the group consisting of bath mats, bath tub mats, shower mats, floor mats, door mats, closet mats, garage mats, automotive mats, breezeway mats, and anti-fatigue mats.

15. The glowing mat device of claim 13 wherein the mat has a substantially rectangular configuration.

16. The glowing mat device of claim 13 wherein the mat is constructed from a cushiony rubber or plastic material.

17. The glowing mat device of claim 13 wherein top surface of the mat includes a nonskid coating.

18. The glowing mat device of claim 17 wherein the bottom surface of the mat includes a plurality of suction cups.

19. The glowing mat device of claim 13 wherein the mat is constructed from a material selected from the group consisting of cushiony and plush fabric, vinyl, foam, memory foam, and recycled plastic and rubber.

20. The glowing mat device of claim 13 wherein the phosphor substance is selected from the group consisting of Zinc Sulfide and Strontium Aluminate.
